(19) United States
(12) Patent Application Publication
(10) Pub. No.: US 2016/0282681 A1
(43) Pub. Date: Sep. 29, 2016

(54) ARRAY SUBSTRATE AND LIQUID CRYSTAL DISPLAY PANEL

(71) Applicant: SHENZHEN CHINA STAR OPTOELECTRONICS TECHNOLOGY CO., LTD., Shenzhen ,Guangdong (CN)

(72) Inventors: Jiali JIANG, Shenzhen, Guangdong (CN); Ming-hung SHIH, Shenzhen, Guangdong (CN)

(73) Assignee: Shenzhen China Star Optoelectronics Technology Co., Ltd., Shenzhen , Guangdong (CN)

(21) Appl. No.: 14/408,661

(22) PCT Filed: Nov. 13, 2014
(86) PCT No.: PCT/CN2014/090996

§ 371 Date: Dec. 17, 2014

(30) Foreign Application Priority Data
Nov. 5, 2014 (CN) 201410620911.4

(51) Int. Cl. G02F 1/1343; G02F 1/1333; G02F 1/1335

(52) U.S. Cl. CPC G02F 1/134309; G02F 1/133514; G02F 1/133345; G02F 1/13439

(57) ABSTRACT

An array substrate and a liquid crystal display panel. Multiple pixel electrodes are formed on the array substrate and arranged as a matrix. Multiple protrusion structures are formed on each of the pixel electrodes. Wherein, in a row of the pixel electrodes, distances between the protrusion structures on the pixel electrodes at two sides are greater than distances between the protrusion structures on the pixel electrodes at middle. The uniformity of the screen brightness of the present invention can be improved.

### BACKGROUND OF THE INVENTION

1. Field of the Invention

The present invention relates to the liquid crystal display technology field, and more particular to an array substrate and a liquid crystal display panel.

2. Description of Related Art

A liquid crystal display (LCD) panel has many advantages such as a wide viewing angle, fast response, accurate color displaying, and low power consumption. As a result, the LCD panel has become the mainstream in the display panel market.

When driving the LCD panel to display, a scanning method is usually used for driving. In a scanning time, a scanning driver applies a scanning signal to a scanning line such that a row of switches are turned on. Then, a data driver applies a display signal to a row of pixel electrodes so as to realize the screen display of the LCD panel.

In the driver circuit, two sides of a scanning line are respectively connected with a scanning driver. The scanning signal is inputted from the scanning driver at the two sides of the scanning line. However, because a resistor-capacitor (RC) delay of the scanning signal of the scanning line, the waveform of the scanning signal is distorted. That is, when transmitting original normal waveform of the scanning signal to the middle of the scanning line from the two sides, the scanning signal is gradually reduced because of the RC delay. Specifically, in the middle of the scanning line, the scanning signal is reduced seriously such that charge rates of the pixel electrodes at the middle portion of the LCD panel are reduced. As a result, voltages at the middle portion of the LCD panel are lower than voltages at two sides of the LCD panel. The brightness at the two sides of the LCD panel is greater than the brightness at the middle of the LCD panel so that the uniformity of the LCD panel is reduced.

### SUMMARY OF THE INVENTION

The technology problem solved by the present invention is to provide an array substrate and a liquid crystal display panel in order to solve the uniformity of the screen brightness.

In order to solve the above problem, a technology solution of the present invention is: an array substrate, comprising: a substrate; an insulation layer formed on the substrate; multiple pixel electrodes formed on the substrate and arranged as a matrix, wherein, the multiple pixel electrodes are transparent and are a single-piece structure, and cover on the insulation layer; the insulation layer is provided with multiple protrusion areas such that multiple pixel electrodes are provided with multiple protrusion structures; wherein, in a row of the multiple pixel electrodes, distances between the protrusion structures are gradually increased from the pixel electrodes at middle to the pixel electrodes at two sides.

Wherein, in the row of the multiple pixel electrodes, sizes of the protrusion structures are gradually decreased from the pixel electrodes at middle to the pixel electrodes at two sides such that the distances between the protrusion structures are gradually increased from the pixel electrodes at middle to the pixel electrodes at two sides.

Wherein, a cross-sectional shape of each protrusion structure is a triangle.

In order to solve the above problem, a technology solution of the present invention is: an array substrate, comprising: a substrate; multiple pixel electrodes formed on the substrate, wherein, multiple protrusion structures are formed on the multiple pixel electrodes; wherein, in a row of the multiple pixel electrodes, distances between the protrusion structures of the pixel electrodes at two sides are greater than distances between the protrusion structures of the pixel electrodes at middle.

Wherein, in the row of the multiple pixel electrodes, the distances between the protrusion structures are gradually increased from the pixel electrodes at middle to the pixel electrodes at two sides.

Wherein, in the row of the multiple pixel electrodes, sizes of the protrusion structures are gradually decreased from the pixel electrodes at middle to the pixel electrodes at two sides such that the distances between the protrusion structures are gradually increased from the pixel electrodes at middle to the pixel electrodes at two sides.

Wherein, the distances between the protrusion structures are gradually increased from the pixel electrodes at middle to the pixel electrodes at two sides by a preset interval; at least two pixel electrodes are within the preset interval; in a same preset interval, the distances between the protrusion structures of the pixel electrodes are the same.

Wherein, the array substrate further comprise an insulation layer formed on the substrate; the multiple pixel electrodes are transparent and are a single-piece structure, and cover on the insulation layer; the insulation layer is provided with multiple protrusion areas such that the multiple protrusion structures are formed on the multiple pixel electrodes.

In order to solve the above problem, a technology solution of the present invention is: a liquid crystal display panel, comprising: an array substrate formed with multiple pixel electrodes which are arrange as a matrix, and each of the multiple pixel electrodes is formed with multiple protrusion structures; a color filter substrate; and a liquid crystal layer disposed between the array substrate and the color filter substrate; wherein, in a row of the pixel electrodes, distances between the protrusion structures of the pixel electrodes at two sides are greater than distances between the protrusion structures of the pixel electrodes at middle.

Wherein, in the row of the pixel electrodes, the distances between the protrusion structures are gradually increased from the pixel electrode at middle to the pixel electrodes at two sides.

Wherein, sizes of the protrusion structures are gradually decreased from the pixel electrode at middle to the pixel electrodes at two sides such that the distances between the protrusion structures are gradually increased from the pixel electrodes at middle to the pixel electrodes at two sides.

Wherein, the array substrate further comprise an insulation layer; the multiple pixel electrodes are transparent and are a single-piece structure, and cover on the insulation layer; the insulation layer is provided with multiple protrusion areas such that multiple protrusion structures are formed on the multiple pixel electrodes.

The beneficial effects of the present invention: comparing to the prior art, in the array substrate of the present invention, multiple protrusion structures are formed on the pixel electrodes. In a row of the pixel electrodes, distances between the protrusion structures of the pixel electrodes at two sides are greater than distances between the protrusion structures of the pixel electrodes at middle. Accordingly, the electric field strength at the pixel electrodes at two sides is lower than the electric field strength at the pixel electrodes at middle. When the electric field strength is lower, the control ability to the liquid crystal molecules is also lower such that the tilting degree of the liquid crystal molecules is lower. Thus, the light transmittance of the liquid crystal molecules at the pixel electrodes at two sides is lower than the light transmittance of the liquid crystal molecules at the pixel electrodes at the middle such that a screen brightness corresponding to the pixel electrodes at two sides is lower than a screen brightness corresponding to the pixel electrodes at the middle. Therefore, the high screen brightness at the two sides because of the RC delay is eliminated or compensated such that screen brightness at two sides and the screen brightness at middle tend to be the same so as to increase the uniformity of the screen brightness.

### BRIEF DESCRIPTION OF THE DRAWINGS

FIG. 1 is a schematic diagram of an array substrate according to an embodiment of the present invention;

FIG. 2 is a cross-sectional view along a CD direction of the array substrate shown in FIG. 1;

FIG. 3 is a schematic diagram of an array substrate according to another embodiment of the present invention;

FIG. 4 is a cross-sectional view along an EF direction of the array substrate shown in FIG. 3;

FIG. 5 is a schematic diagram of an array substrate according to another embodiment of the present invention;

FIG. 6 is a cross-sectional view along a MN direction of the array substrate shown in FIG. 5;

FIG. 7 is a cross-sectional view of an array substrate according to another embodiment of the present invention; and

FIG. 8 is a schematic diagram of an array substrate according to an embodiment of the present invention.

### DETAILED DESCRIPTION OF THE PREFERRED EMBODIMENT

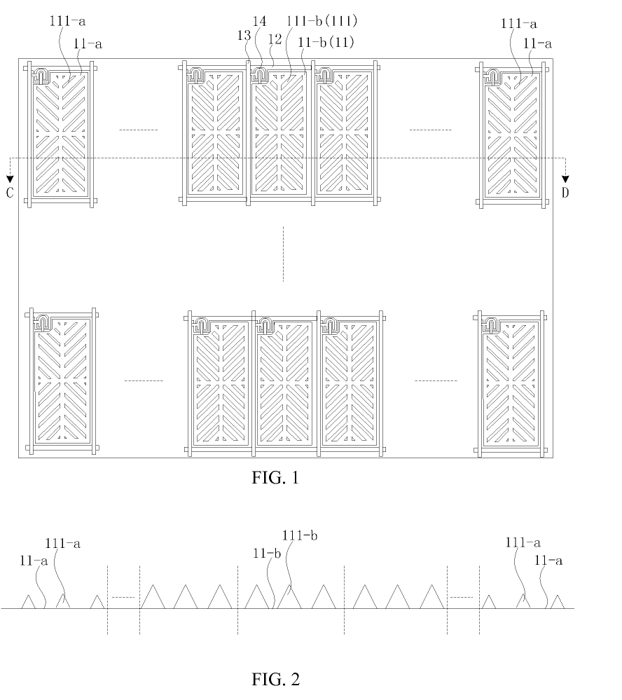

With reference to FIG. 1 and FIG. 2, wherein, FIG. 1 is a schematic diagram of an array substrate according to an embodiment of the present invention; FIG. 2 is a cross-sectional view along a CD direction of the array substrate shown in FIG. 1, that is, a cross-sectional view of a row of pixel electrodes. Wherein, FIG. 2 only shows a cross-sectional view of protrusion structures.

In the present embodiment, multiple pixel electrodes 11 are formed on the array substrate and are arranged as a matrix. Besides, multiple scanning lines 12 for driving the multiple pixel electrodes 11, multiple data lines 13 and multiple thin-film transistors 14 are also formed on the array substrate. Each of the pixel electrodes 11 is respectively connected with drain electrode of the thin-film transistor 14. The scanning lines 12 are connected with gate electrodes of the thin-film transistors 14. The scanning lines 12 are used to control the turning on and off of the thin-film transistors 14. The data lines 13 are connected with source electrodes of the thin-film transistors 14 and the data lines 13 are used for inputting a display signal to the pixel electrodes through the thin-film transistors 14 when the thin-film transistors 14 are turned on. In the present embodiment, a row scanning method is used for scanning such that one scanning line 12 is used for driving a row of the pixel electrodes.

Wherein, multiple protrusion structures 111 are formed on each of the pixel electrodes 11. The multiple protrusion structures 111 are used for realizing the alignment of the liquid crystal molecules. As shown in FIG. 1, in this embodiment, the multiple protrusion structures 111 on the pixel electrodes 11 are arranged as a “*” shape so that the multiple protrusion structures 111 have four tilting directions. When a voltage is applied, the electric field strength on the surface of the protrusion structure 111 and the electric field strength of a cave portion between the protrusion structures 111 are not the same such that electric field lines in that region are inclined. The liquid crystal molecules are tilted along a specific direction in the inclined electric field lines. Finally, four liquid crystal domains with four tilting directions are formed in order to realize the multiple domains of the liquid crystal molecules in order to increase the viewing angle.

Wherein in a row of the pixel electrodes 11, for different pixel electrodes 11, distances between the protrusion structures 111-a on the pixel electrodes 11-a at two sides of the LCD panel are greater than distances between the protrusion structures 111-b on the pixel electrodes 11-b at the middle of the LCD panel. As shown in FIG. 2, the protrusion structures 111-b on the pixel electrodes 11-b at the middle of the LCD panel and the protrusion structures 111-a on the pixel electrodes 11-a at two sides of the LCD panel are the same in shape, but different in size. That is, the sizes of the protrusion structures 111-b on the pixel electrodes 11-b at the middle of the LCD panel are greater than the sizes of the protrusion structures 111-a on the pixel electrodes 11-a at two sides of the LCD panel. A contact area of each protrusion structures 111-b on the pixel electrodes 11-b at the middle of the LCD panel and the pixel electrodes 11-b is greater than a contact area of each protrusion structures 111-a on the pixel electrodes 11-a at two sides of the LCD panel and the pixel electrodes 11-a. As a result, under the condition that the arrangement positions are substantially the same, distances between the protrusion structures 111-a on the pixel electrodes 11-a at two sides of the LCD panel is greater than distances between the protrusion structures 111-b on the pixel electrodes 11-b at the middle of the LCD panel.

Wherein, the sizes of the protrusion structures 111-a on the pixel electrodes 11-a at two sides can be adjusted according to the distortion degree of the scanning signal. The only requirement is to satisfy the alignment of the liquid crystal molecules and the thing that the distances between the protrusion structures 111-a on the pixel electrodes 11-a at two sides are greater than the distances between the protrusion structures 111-b on the pixel electrodes 11-b at the middle of the LCD panel at the same time.

When a voltage is applied, the electric field strength at the surface of the protrusion structure 111 is greater than the electric field strength at the cave portion between the protrusion structures 111. For the pixel electrodes 11-a at two sides, the distance between the protrusion structures 111-a is greater than the distance between the protrusion structures 111-b on the pixel electrodes 11-b at middle of the LCD panel. That is, an area of the cave portion between the protrusion structures 111-a on the pixel electrode 11-a at two sides is greater than an area of the cave portion on the pixel electrode 11-b at middle such that a total electric field strength at the pixel electrodes 11-a at two sides is lower than a total electric field strength at the pixel electrodes 11-b at middle. Through the distances between the protrusion structures 111-a on the pixel electrodes 11-a at two sides of the LCD panel are greater, the electric field lines generated by the pixel electrodes 11-a at two sides are weakened.

When the electric field strength is lower, the control ability to the liquid crystal molecules is also lower such that the tilting degree of the liquid crystal molecules is lower. Thus, the light transmittance of the liquid crystal molecules at the pixel electrodes at two sides is lower than the light transmittance of the liquid crystal molecules at the pixel electrodes at the middle such that a screen brightness corresponding to the pixel electrodes at two sides is lower than a screen brightness corresponding to the pixel electrodes at the middle. Therefore, the high screen brightness at the two sides because of the RC delay is eliminated or compensated such that screen brightness at two sides and the screen brightness at middle tend to be the same so as to increase the uniformity of the screen brightness.

Wherein the row of the pixel electrodes described by the present embodiment means that the pixel electrodes extend along a row direction and correspond to one scanning line for driving the row of the pixel electrodes. In another embodiment, when a column scanning method is used for scanning, that is, the scanning line extends along a column direction and one scanning line is used for driving a column of pixel electrodes, the row of the pixel electrodes described above means the column of the pixel electrodes. At this time, in the column of the pixel electrodes, distances between the protrusion structures on the pixel electrodes at two sides are greater than distances between the protrusion structures on the pixel electrodes at middle.

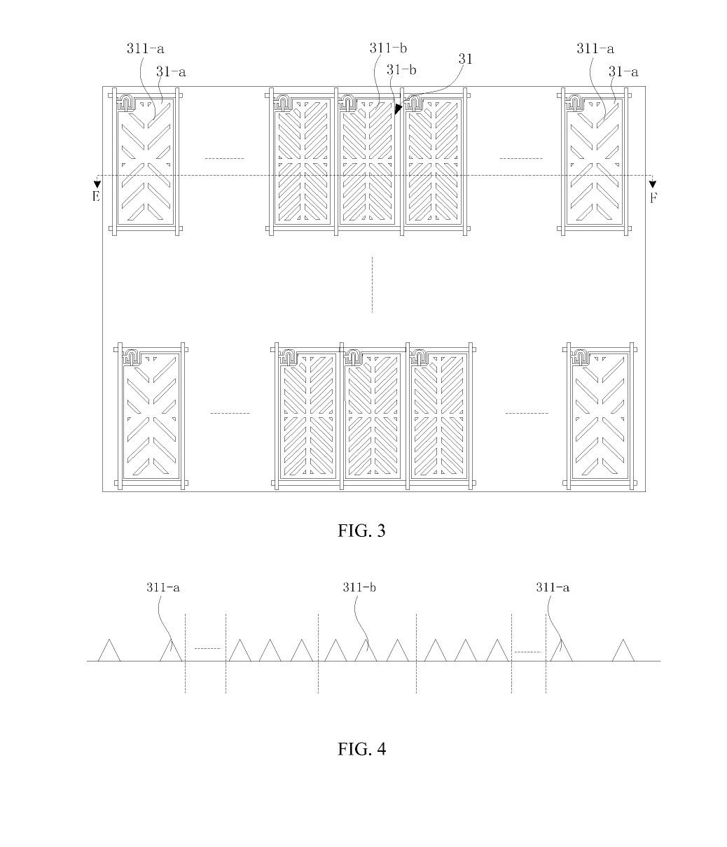

In another embodiment of the array substrate of the present invention, with reference to FIG. 3 and FIG. 4, in a row of pixel electrodes 31, for different pixel electrodes 31, protrusion structures 311-a on the pixel electrodes 31-a at two sides and the protrusion structures 311-b on the pixel electrodes 31-b are the same in size and shape, but different in amount. A contact area of the protrusion structure 311-a and the pixel electrodes 31-a on the pixel electrode 31-a at two sides and a contact area of the protrusion structure 311-b and the pixel electrodes 31-b on the pixel electrode 31-b at middle are the same. Through reducing the number of the protrusion structures 311-a on the pixel electrodes 31-a at two sides, distances between the protrusion structures 311-a on the pixel electrodes 31-a at two sides are greater than distances between the protrusion structures 311-b on the pixel electrodes 31-b at middle. Therefore, the electric field strength at the pixel electrodes 31-a at two sides is weakened in order to reduce the control ability of the pixel electrodes 31-a at two sides to the liquid crystal molecules. As a result, the light transmittance at the pixel electrodes 31-a at two sides is reduced in order to eliminate or compensate the screen brightness at two sides and the screen brightness at middle tend to be the same so as to increase the uniformity of the screen brightness.

It should be noted that in the above embodiments, only one pixel electrode 11-b is denoted, and only one pixel electrode 11-a is denoted respectively at two sides. One of ordinary skill in the art can understand that according to the distortion degree, the pixel electrodes 11-b can represent two or more pixel electrodes located in the middle of the LCD panel and corresponding to the distortion degree of the scanning signal, and the pixel electrodes 11-a can represent two or more pixel electrodes located at two sides of the LCD panel and corresponding to the distortion degree of the scanning signal. Specifically, according to the distortion degree, in the row of the pixel electrodes, disposing that the distances between the protrusion structures on the pixel electrodes at middle are greater than the distances between the protrusion structures on the pixel electrodes at two sides.

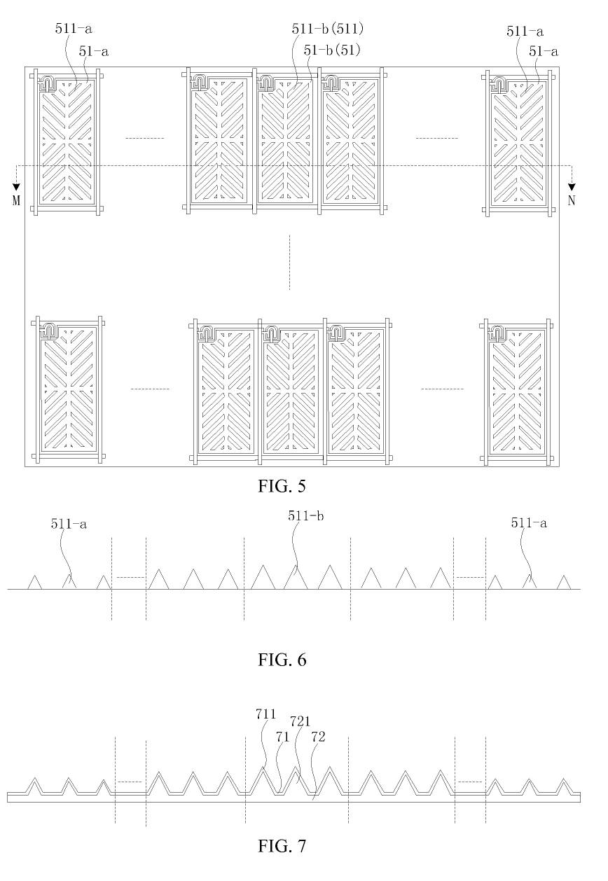

In order to further improve the uniformity of the screen brightness, and in another embodiment of the array substrate of the present invention, as shown in FIG. 5 and FIG. 6, in a row of pixel electrodes 51, distances between the protrusion structures 511 are gradually increased from the pixel electrodes 51-b at middle to the pixel electrodes 51-a at two sides. A scanning signal is inputted into a scanning line from the two sides. Therefore, the distortion degree of the scanning signal is gradually increased from the two sides to the middle such that the screen brightness is gradually brighter from the middle to the two sides. The present embodiment gradually increases the distances between the protrusion structures 511 from the pixel electrodes 51-b at middle to the pixel electrodes 51-a at two sides. That is, the distances between the adjacent two protrusion structures 511 on the pixel electrodes 51 are not the same. The distances between the protrusion structures on the pixel electrodes 51 are greater when closer to the two sides.

Thus, when a voltage is applied, in a row of pixel electrodes 51, a total electric field strength is gradually decreased from the middle to the two sides such that the light transmittance is also decreased from the middle to the two sides so as to eliminate or compensate the gradual increment of the brightness from the middle to the two sides because of the distortion of the scanning signal. As a result, the light transmittance everywhere is substantially the same, and further improves the uniformity of the screen brightness.

However, in the present embodiment, the distances between the protrusion structures on different pixel electrodes are changed by changing the sizes of the protrusion structures. As shown in FIG. 6, in a row of the pixel electrodes 61, the sizes of the protrusion structures are gradually decreased from the pixel electrode 51-b at middle to the pixel electrodes 51-a at two sides such that the distances between protrusion structures are gradually increased from the pixel electrodes 51-b at the middle to the pixel electrodes 51-a at two sides.

In another embodiment of the array substrate of the present invention, in order to reduce the process requirement, the distances between the protrusion structures can gradually increase with a preset interval. Specifically, in a row of the pixel electrodes, the distances between the protrusion structures can gradually increase from the pixel electrodes at middle to the pixel electrodes at two sides with the preset interval. That is, the distances between the protrusion structures can gradually increase from the middle to the two sides as a ladder shape.

Wherein, multiple pixel electrodes are within the preset interval, and in a same preset interval, distances between the protrusion structures are equal. The scanning signal delays more seriously when a distance from the input terminal of the scanning line is farther. In the same preset interval, the delay difference of the scanning signal of the scanning line is smaller. Therefore, in the present embodiment, the distances between the protrusion structures within the same preset interval are the same. However, the distances between the protrusion structures within another preset interval are different. The distances between the protrusion structures on the pixel electrodes closer to the input terminal of the scanning line are greater.

By the above-described manner, the uniformity of screen brightness can be increased. In the same preset interval, the distances between the adjacent two protrusion structures are the same so that the process requirement can be reduced. Wherein, the present interval can be adjusted according to actually delay situation of the scanning signal.

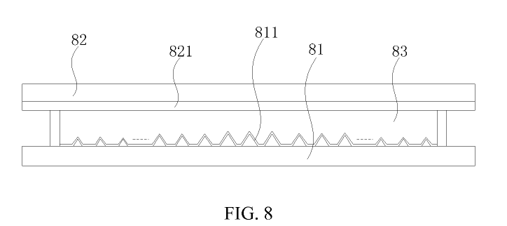

With reference to FIG. 7, in another embodiment of the array substrate of the present invention, the array substrate further comprises an insulation layer 72. Distances between adjacent two protrusion structures 711 on the pixel electrodes 71 are gradually increased from the pixel electrodes at middle to the pixel electrodes at two sides in order to increase the uniformity of the screen brightness. Wherein, in the present embodiment, the pixel electrodes 71 and the protrusion structures 711 are formed integrally. That is, each of the protrusion structures 711 is a portion of each of the pixel electrodes 71.

Furthermore, each of the pixel electrodes 71 is transparent and is a single-piece structure. Each of the pixel electrodes 71 covers on the insulation layer 72. That is, no slit is disposed on each of the pixel electrodes 71, and utilizing the protrusion structures 711 to realize the alignment of the liquid crystal molecules. Accordingly, comparing to the conventional art that disposes the slits on the pixel electrodes to control the alignment of the liquid crystal molecules. In the present embodiment, the pixel electrodes 71 are covered on the insulation layer 72 by the single-piece structure. Because no slit is existed, the electric field lines are complete so as to increase the control ability to the liquid crystal molecules in order to increase the light transmittance. Comparing to the pixel electrodes having slits, the pixel electrodes having the single-piece structure can increase the light transmittance about 3%.

Furthermore, the insulation layer 72 is provided with multiple protrusion areas 721. When the pixel electrodes 71 cover on the insulation layer 72, the pixel electrodes at the protrusion areas 721 of the insulation layer 72 also protrude outward so as to form the protrusion structures 711 of the pixel electrodes 71.

Wherein, a cross-sectional shape of the protrusion structure 711 is a triangle. At this time, a cross-sectional shape of the protrusion area 721 of the insulation layer 72 is also a triangle. Of course, the cross-sectional shape can also be a rectangle or an irregular quadrilateral.

Wherein, the insulation layer 72 functions as a protective layer between the pixel electrodes 71 and thin-film transistors. The protective layer is used for insulating the pixel electrodes 71 and thin-film transistors. In another embodiment, the insulation layer 72 can also be a gate insulation layer used for covering the gates of the thin-film transistors.

In another embodiment of the array substrate of the present invention, the electric field strength at the pixel electrodes at two sides is weakened through changing the heights of the protrusion structures. In a row of the pixel electrodes, each distance between the protrusion structures is the same. The heights of the protrusion structures are gradually reduced from the pixel electrodes at middle to the pixel electrodes at two sides. The height of the protrusion structure is higher; the electric field strength is stronger. Therefore, through the heights of the protrusion structures of the pixel electrodes at two sides are lower than the heights of the protrusion structures of the pixel electrodes at middle; the electric field strength at the pixel electrodes at two sides is lower than the electric filed strength at the pixel electrodes at middle. Accordingly, the higher screen brightness at two sides caused by the delay of the scanning signal can be reduced, and the uniformity of the screen brightness can be improved.

With reference to FIG. 8, in an embodiment of the liquid crystal display (LCD) panel of the present invention, the LCD panel includes an array substrate 81, a color filter substrate 82, and a liquid crystal layer located between the array substrate 81 and the color filter substrate 82.

Wherein, the array substrate 81 is the array substrate described in anyone of the above embodiments. A common electrode 821 is formed on the color filter substrate 82. Wherein, the common electrode 821 is transparent and is a single-piece structure. Through applying a common voltage on the common electrode 821 and a display voltage on the pixel electrodes 811 on the array substrate 81 to control the tilting of the liquid crystal molecules in order to realize the display of the LCD panel. In the present embodiment, in a row of the pixel electrodes 811, distances between the protrusion structures of the pixel electrodes at two sides are greater than distances between the protrusion structures of the pixel electrodes at middle such that the electric field strength at the pixel electrodes at two sides is lower than electric field strength at the pixel electrodes at middle. Accordingly, the control ability of the pixel electrodes at two sides to the liquid crystal molecules is weakened in order to reduce the screen brightness at two sides so as to increase the uniformity of the screen brightness.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. An array substrate, comprising:
a substrate;
an insulation layer formed on the substrate;
multiple pixel electrodes formed on the substrate and arranged as a matrix, wherein, the multiple pixel electrodes are transparent and are a single-piece structure, and cover on the insulation layer; the insulation layer is provided with multiple protrusion areas such that multiple pixel electrodes are provided with multiple protrusion structures;
wherein, in a row of the multiple pixel electrodes, distances between the protrusion structures are gradually increased from the pixel electrodes at middle to the pixel electrodes at two sides.

2. The array substrate according to claim 1, wherein, in the row of the multiple pixel electrodes, sizes of the protrusion structures are gradually decreased from the pixel electrodes at middle to the pixel electrodes at two sides such that the distances between the protrusion structures are gradually increased from the pixel electrodes at middle to the pixel electrodes at two sides.

3. The array substrate according to claim 1, wherein, a cross-sectional shape of each protrusion structure is a triangle.

4. An array substrate, comprising:
a substrate;
multiple pixel electrodes formed on the substrate, wherein, multiple protrusion structures are formed on the multiple pixel electrodes;
wherein, in a row of the multiple pixel electrodes, distances between the protrusion structures of the pixel electrodes at two sides are greater than distances between the protrusion structures of the pixel electrodes at middle.

5. The array substrate according to claim 4, wherein, in the row of the multiple pixel electrodes, the distances between the protrusion structures are gradually increased from the pixel electrodes at middle to the pixel electrodes at two sides.

6. The array substrate according to claim 5, wherein, in the row of the multiple pixel electrodes, sizes of the protrusion structures are gradually decreased from the pixel electrodes at middle to the pixel electrodes at two sides such that the distances between the protrusion structures are gradually increased from the pixel electrodes at middle to the pixel electrodes at two sides.

7. The array substrate according to claim 4, wherein, the distances between the protrusion structures are gradually increased from the pixel electrodes at middle to the pixel electrodes at two sides by a preset interval; at least two pixel electrodes are within the preset interval; in a same preset interval, the distances between the protrusion structures of the pixel electrodes are the same.

8. The array substrate according to claim 4, wherein, the array substrate further comprise an insulation layer formed on the substrate; the multiple pixel electrodes are transparent and are a single-piece structure, and cover on the insulation layer; the insulation layer is provided with multiple protrusion areas such that the multiple protrusion structures are formed on the multiple pixel electrodes.

9. The array substrate according to claim 4, wherein, a cross-sectional shape of each protrusion structure is a triangle.

10. A liquid crystal display panel, comprising:
an array substrate formed with multiple pixel electrodes which are arrange as a matrix, and each of the multiple pixel electrodes is formed with multiple protrusion structures;
a color filter substrate; and
a liquid crystal layer disposed between the array substrate and the color filter substrate;
wherein, in a row of the pixel electrodes, distances between the protrusion structures of the pixel electrodes at two sides are greater than distances between the protrusion structures of the pixel electrodes at middle.

11. The liquid crystal display panel according to claim 10, wherein, in the row of the pixel electrodes, the distances between the protrusion structures are gradually increased from the pixel electrode at middle to the pixel electrodes at two sides.

12. The liquid crystal display panel according to claim 11, wherein, sizes of the protrusion structures are gradually decreased from the pixel electrode at middle to the pixel electrodes at two sides such that the distances between the protrusion structures are gradually increased from the pixel electrodes at middle to the pixel electrodes at two sides.

13. The liquid crystal display panel according to claim 10, wherein, the array substrate further comprise an insulation layer; the multiple pixel electrodes are transparent and are a single-piece structure, and cover on the insulation layer; the insulation layer is provided with multiple protrusion areas such that multiple protrusion structures are formed on the multiple pixel electrodes.

14. The liquid crystal display panel according to claim 10, wherein, a cross-sectional shape of each protrusion structure is a triangle.
